(19) United States
(12) Patent Application Publication
(10) Pub. No.: US 2012/0019356 A1
(43) Pub. Date: Jan. 26, 2012

(54) FINGERPRINT SCANNER

(76) Inventors: Eric Gagneraud, Houston, TX (US); Alexis Aimard, Houston, TX (US)

(21) Appl. No.: 13/260,318

(22) PCT Filed: Apr. 29, 2009
(86) PCT No.: PCT/US09/42157

§ 371 Date: Sep. 25, 2011

(51) Int. Cl. G08B 29/00; G06F 7/04

(52) U.S. Cl. 340/5.32; 340/5.83; 340/5.53

(57) ABSTRACT

A machine including a processor, a power button, a fingerprint scanner coupled on the power button, and an authentication application executable by the processor for comparing a user fingerprint image with a stored fingerprint image.

### BACKGROUND

When powering on a machine such as a computing device, a user presses a power button switch on the machine. After the machine receives power, hardware and software components of the machine are loaded. The user gains access to the machine by logging into the machine with a registered password using an input device, such as a mouse or keyboard.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a block diagram of a machine with a fingerprint scanner according to an embodiment of the invention.

FIG. 2 illustrates a device having a fingerprint scanner on a power button and coupled to additional components according to an embodiment of the invention.

FIG. 3 illustrates a laptop that is powered on when a fingerprint scanner detects a user according to an embodiment of the invention.

FIG. 4 illustrates a fingerprint scanner on a power button and a status indicator positioned on a lid of a laptop according to an embodiment of the invention.

FIG. 5 illustrates a fingerprint scanner on a power button and a status indicator positioned on a base of a laptop according to an embodiment of the invention.

FIG. 6 illustrates timelines of a fingerprint scanner scanning a fingerprint, a machine powering on, and a lid of the machine unlocking according to an embodiment of the invention.

FIG. 7 is a flow chart illustrating a method for authenticating a user according to an embodiment of the invention.

FIG. 8 is a flow chart illustrating a method for authenticating a user according to another embodiment of the invention.

### DETAILED DESCRIPTION

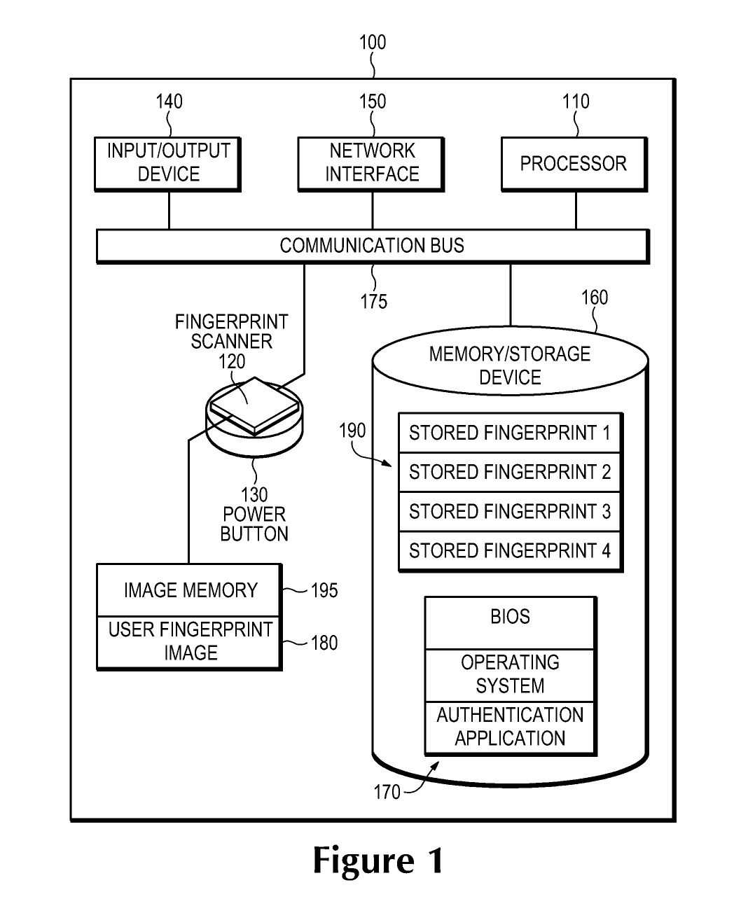

FIG. 1 illustrates a block diagram of a machine 100 with a fingerprint scanner 120 according to an embodiment of the invention. In one embodiment, the machine 100 is a desktop, a laptop, a server, and/or any device that includes a fingerprint scanner 120. As illustrated in FIG. 1, the machine 100 includes a processor 110, a fingerprint scanner 120 coupled to a power button 130, an input/output device 140, a network interface 150, a storage device 160, an authentication application 170, and a communication bus 175 for the machine 100 and/or one or more components of the machine 100 to communicate with one another. In other embodiments, the machine 100 includes additional components and/or is coupled to additional components in addition to and/or in lieu of those noted above and illustrated in FIG. 1.

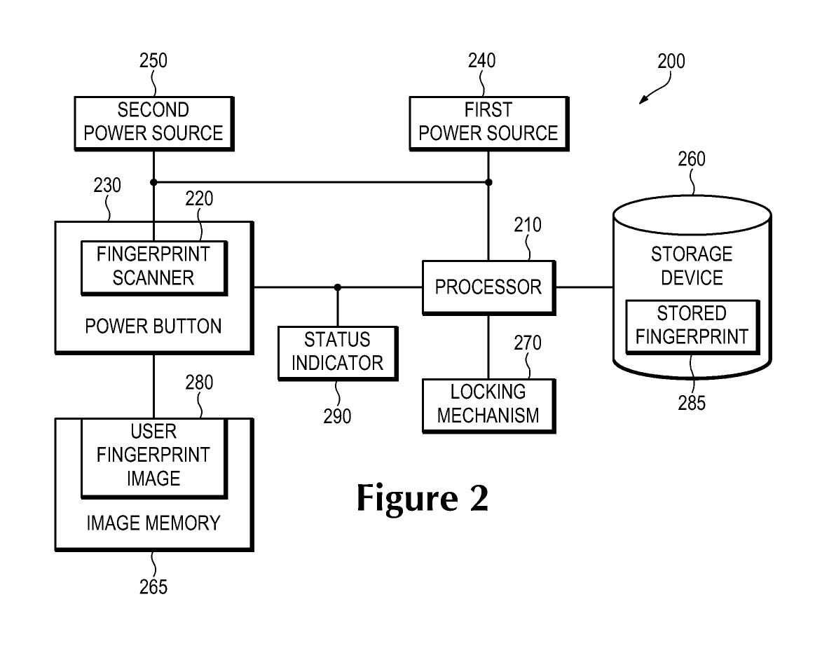

As noted above, the machine 100 includes a processor 110. The processor 110 receives and executes instructions for various components and/or applications of the machine 100, such as a fingerprint scanner 120 and an authentication application 170. A fingerprint scanner 120 is an optical device that scans an image of a user's fingerprint when the fingerprint scanner detects the user. In one embodiment, the fingerprint scanner 120 is disposed on an exterior of the machine 100, such as a lid of a laptop. In one embodiment, the fingerprint scanner 120 detects a user when the user touches or presses the fingerprint scanner 120 with a finger. In other embodiments, the fingerprint scanner 120 detects the user when the user's finger is within proximity of the fingerprint scanner 120. Additionally, the fingerprint scanner 120 is coupled to at least one power source (FIG. 2) on the machine 100 and receives power while the machine 100 is powered off.

For the purposes of this application, the machine 100 is powered on when a BIOS and an operating system of the machine 100 have been loaded. Additionally, powering on the machine 100 is a process that includes, but is not limited to, loading the BIOS and the operating system on the machine 100. Once the operating system has finished loading, the process of powering on the machine 100 is complete and the machine 100 is powered on. Additionally, the machine 100 is powered off when the machine 100 is not powered on and is not in the process of powering on. While the machine 100 is powered off, the fingerprint scanner 120 receives power while other components of the machine 100 do not receive power.

When a user touches the fingerprint scanner 120 with a finger, an optical device on the fingerprint scanner 120 begins to scan an image of the user's fingerprint. Further, when the fingerprint scanner 120 has finished scanning the user's fingerprint, a user fingerprint image 180 is created and stored as an image file. In one embodiment, the user fingerprint image 180 is stored on an image memory 195 included in the fingerprint scanner 120. In another embodiment, the user fingerprint image 180 is stored on a storage device 160 accessible to the machine 100. The image memory 195 is memory directly coupled to and included in the fingerprint scanner 120. In some embodiments, the image memory 195 is a part of the fingerprint scanner 120. The image memory 195 is configured to store the user fingerprint image 180.

In other embodiments, the image memory 195 is further configured to contain stored fingerprints 190. The machine 100 compares the user fingerprint image 180 with the stored fingerprints 190 during a user authentication process. As illustrated in FIG. 1, the fingerprint scanner 120 is coupled on a power button 130 included in the machine 100. As shown in FIG. 1, in one embodiment, the power button 130 is coupled below the fingerprint scanner 120. As a result, the fingerprint scanner 120 overlaps the power button 130.

Additionally, the fingerprint scanner 120 includes a sensor. The sensor is included in the fingerprint scanner 120 and used by the fingerprint scanner 120 when detecting a user. In one embodiment, the sensor is a touch sensitive device that will detect a user for the fingerprint scanner 120 when the user touches or presses the fingerprint scanner 120 with a finger. In other embodiments, the sensor is a proximity device that detects a user for the fingerprint scanner 120 when the user's finger is within proximity of the fingerprint scanner 120. Additionally, as shown in FIG. 1, the power button 130 is coupled on the fingerprint scanner 120. The power button 130 is operationally coupled to a switch on the machine 100 that sends an instruction for the machine 100 to begin powering on when it receives a signal from the fingerprint scanner 120.

In one embodiment, when the fingerprint scanner 120 detects a user, the fingerprint scanner 120 sends a signal to the power button 130 on the machine 100. The fingerprint scanner 120 will begin to scan the user's fingerprint and store it as a user fingerprint image 180. Additionally, when the power button 130 receives the signal from the fingerprint scanner 120, the machine 100 will also begin powering on. As a result, the machine 100 is powered on in response to the fingerprint scanner 120 detecting a user. Additionally, the machine 100 will concurrently be powering on while the fingerprint scanner 120 is scanning the user's fingerprint.

The BIOS is a basic input/output system that initializes and controls hardware components and an operating system of the machine 100. The BIOS loads the operating system while the machine 100 is powering on and is stored on a storage device 160 accessible the machine 100. In one embodiment, the storage device 160 is included in the machine 100. In other embodiments, the storage device 160 is external and accessible to the machine 100. In one embodiment, the BIOS is stored in an embedded memory, included in the storage device 160.

An operating system acts as an interface between the user and the components of the machine 100. In one embodiment, the operating system is stored in the storage device 160. Additionally, the operating system includes user accounts that a user accesses once the machine 100 authenticates the user. A user is authenticated when the user has verified an identity with the operating system. In one embodiment, the user verifies an identity through the fingerprint scanner 120. As noted above, the fingerprint scanner 120 scans a user fingerprint of the user and creates a user fingerprint image 180. The user fingerprint image 180 is a digital image of the user's fingerprint that the fingerprint scanner 120 scans. Additionally, an authentication application 170 on the machine 100 compares the user fingerprint image 180 to stored fingerprint data 190 on the machine 100 in order to authenticate the user.

The stored fingerprint 190 is digital information of user fingerprints that the machine recognizes. In one embodiment, the stored fingerprints 190 are characteristics of the user fingerprints that are stored as data, such as corresponding specific points or portions in the user fingerprints that is distinct from other fingerprints. In other embodiments, the stored fingerprints 190 are digital fingerprint images of user fingerprints that the machine 100 recognizes. In one embodiment, the user fingerprint image 180 and the stored fingerprints 190 are stored in the storage device 160 on the machine 100. In another embodiment, the user fingerprint image 180 and the stored fingerprints 190 are stored in an image memory 195. In other embodiments, the user fingerprint image 180 is stored in the image memory 195 and the stored fingerprints 190 are stored on the storage device 160.

The stored fingerprints 190 are created by users scanning their fingerprints with the fingerprint scanner 120 and registering their corresponding stored fingerprints 190 with user accounts in the operating system of the machine 100. In other embodiments, the stored fingerprints 190 are downloaded from additional devices through a network interface 150 and/or an input/output device 140 on the machine 100. In one embodiment, the network interface 150 is a wired or wireless network interface card. Additionally, in one embodiment, the input/output device 140 is a USB drive or an infra red device.

As noted above, the fingerprint scanner 120 will scan the user's fingerprint and store a user fingerprint image 180 on the image memory 195 or the storage device 160. Once the user fingerprint image 180 has been scanned and stored, an authentication application 170 attempts to authenticate the user by comparing the user fingerprint image 180 to the stored fingerprints 190 and scanning for a match. The authentication application 170 is an application that accesses the user fingerprint image 180 stored in the image memory 195 or the storage device 160 and compares the user fingerprint image 180 to stored fingerprints 190. Additionally, the authentication application 170 scans the stored fingerprints 190 to determine whether one of the stored fingerprints 190 match the user fingerprint image 180. In one embodiment, the stored fingerprints 190 are stored fingerprint images, as a result, the authentication application 170 scans the stored fingerprint images to determine whether one of the stored fingerprint images match the user fingerprint image 180.

In one embodiment, the authentication application 170 scans the stored fingerprints 190 for a fingerprint that matches the user fingerprint image 180 as soon as the fingerprint scanner 120 has finished scanning and storing the user fingerprint image 180 and while the machine 100 is powering on. In other embodiments, the authentication application 170 scans the stored fingerprints 190 for a fingerprint image that matches the user fingerprint image 180 after the machine 100 is powered on.

In one embodiment, the authentication application 170 is firmware that is embedded onto the fingerprint scanner 120. In other embodiments, the authentication application 170 is a software application stored on the machine 100 within ROM or on the storage device 160 accessible by the machine 100 or the authentication application 170 is stored on a computer readable medium readable and accessible by the machine 100 and/or the fingerprint scanner 120 from a different location. The authentication application 170 communicates with devices and/or components coupled to the machine 100 physically or wirelessly through a communication bus 175 included in or attached to the machine 100. In one embodiment the communication bus 175 is a memory bus. In other embodiments, the communication bus 175 is a data bus.

The authentication application 170 compares the user fingerprint image 180 to the stored fingerprints 190 one by one and determines whether the user fingerprint image 180 matches any of the stored fingerprints 190. If one of the stored fingerprints 190 matches the user fingerprint image 180, the authentication application 170 sends an instruction to the operating system of the machine 100 to authenticate the user. In some embodiments, when the user has been authenticated, a locking mechanism (FIG. 2, 4, 5) is also configured to unlock. In other embodiments, the locking mechanism is configured to concurrently unlock while the machine 100 is powering on. In one embodiment, the locking mechanism is a device that is configured to lock or unlock for permitting or restricting the opening of a lid of a notebook, netbook, and/or personal computer.

If the user fingerprint image 180 does not match one of the stored fingerprints 190, the authentication application 170 sends an instruction for the fingerprint scanner 120 to scan the user's fingerprint again. In one embodiment, the authentication application 170 also sends an instruction to a status indicator (FIG. 2, 4, 5) on the machine 100 to output an error message when the user fingerprint image 180 does not match one of the stored fingerprints 190. In other embodiments, the authentication application 170 additionally sends an instruction for the locking mechanism (FIG. 2, 4, 5) to remain locked until the user has been authenticated.

FIG. 2 illustrates a device 200 having a fingerprint scanner 220 on a power button 230 and coupled to additional components according to an embodiment of the invention. As illustrated in FIG. 2, the fingerprint scanner 220 is on the power button 230 and overlaps the power button 230. In one embodiment, the fingerprint scanner 220 is also coupled to at least one power source 240, 250 and a processor 210. Additionally, as illustrated in FIG. 2, the processor 210 is also coupled to a status indicator 290, a locking mechanism 270, and a storage device 260. In other embodiments, the fingerprint scanner 220 is coupled to additional components in addition to and/or in lieu of those noted above and illustrated in FIG. 2. The components listed above are included in a machine 200, such as a personal computer or a laptop.

As illustrated in FIG. 2, the fingerprint scanner 220 is coupled to and receives power from the first power source 240 and/or the second power source 250. Further, the components (the processor 210, the status indicator 290, the locking mechanism 270, and the storage device 260) of the machine 200 are coupled to and receive power from the first power source 240. In one embodiment, the first power source 240 and the second power source 250 are power supplies and/or batteries that store and supply power to one or more components, such as the fingerprint scanner 220.

As illustrated in FIG. 2, in one embodiment, the fingerprint scanner 220 is coupled to the first power source 240 and the first power source 240 is configured to supply power to the fingerprint scanner 220 while the machine 200 is powered off. Although the fingerprint scanner 220 receives power from the first power source 240, the machine 200 and the other components of the machine 200 do not receive power and are powered off until the power button 230 is activated. As a result, the fingerprint scanner 220 is active and continues to scan for and detects a user while the machine is powered off.

Once the fingerprint scanner 220 has detected a user, as noted above, the fingerprint scanner 220 sends a signal to the power button 230 to begin powering on the machine 200 and the components of the machine 200. The power button 230 then sends an instruction to the first power source 240 to supply power to the machine 200 and the components (the processor 210, the status indicator 290, the locking mechanism 270, and the storage device 260) so as to begin powering on. Additionally, as illustrated in FIG. 2, the fingerprint scanner 220 is coupled to a second power source 250. The second power source 250 is an additional power source that is configured to store and supply power dedicated to the fingerprint scanner 220 while the machine 200 is powered off. As a result, by using the second power source 250 to supply power to the fingerprint scanner 220, the first power source 240 is not drained by supplying power to the fingerprint scanner 220 and the first power source 240 can still provide power to the machine 200 and the components of the machine 200 while powering on. In other embodiments, the fingerprint scanner 220 may be coupled to a single power source or multiple additional power sources in addition to and/or in lieu of those noted above and illustrated in FIG. 2.

As noted above, when the fingerprint scanner 220 detects a user, the fingerprint scanner 220 scans and stores a user fingerprint image 280 of the user. Once the user fingerprint image 280 has been stored, an authentication application compares the user fingerprint image 280 to stored fingerprints 285 and scans for a match. As noted above, in one embodiment, the user fingerprint image 280 is stored on image memory 265 included in the fingerprint scanner 220 and the stored fingerprints 285 are stored on a storage device 260. When a match is not found, in one embodiment, the authentication application will indicate to the processor 210 that authentication has failed. The processor 210 then sends an instruction for the status indicator 290 to emit a signal indicating that authentication has failed.

The status indicator 290 is a device that emits audio and/or visual signals to a user when a user fingerprint image 280 scanned by the fingerprint scanner 220 does not match any stored fingerprints 285. In another embodiment, the authentication application configures the status indicator 290 through the processor 210 to prompt the user to rescan their fingerprint with the fingerprint scanner 220 when the authentication application has indicated that authentication has failed. In other embodiments, the status indicator 290 is configured to output a signal when the authentication application indicates that the user has been authenticated. In one embodiment, the status indicator 290 is an audio device such as a speaker that emits an auditory signal such as a voice prompt. In other embodiments, the status indicator 290 is a visual device such as a LED or a LCD that emits a visual signal and/or message to the user.

Additionally, as noted above, in one embodiment, a locking mechanism 270 is configured to unlock when the user has been authenticated, while the machine 200 is powering on, or when the machine 200 is powered on. A locking mechanism 270 is a device that restricts access to the machine 200. As illustrated in FIG. 2, the locking mechanism 270 is coupled to the processor 210. In one embodiment, the processor 210 sends instructions to the locking mechanism 270 to remain locked when the authentication application indicates that authentication has failed. In another embodiment, the processor 210 sends instructions to the locking mechanism 270 to unlock when the authentication application indicates that the user has been authenticated.

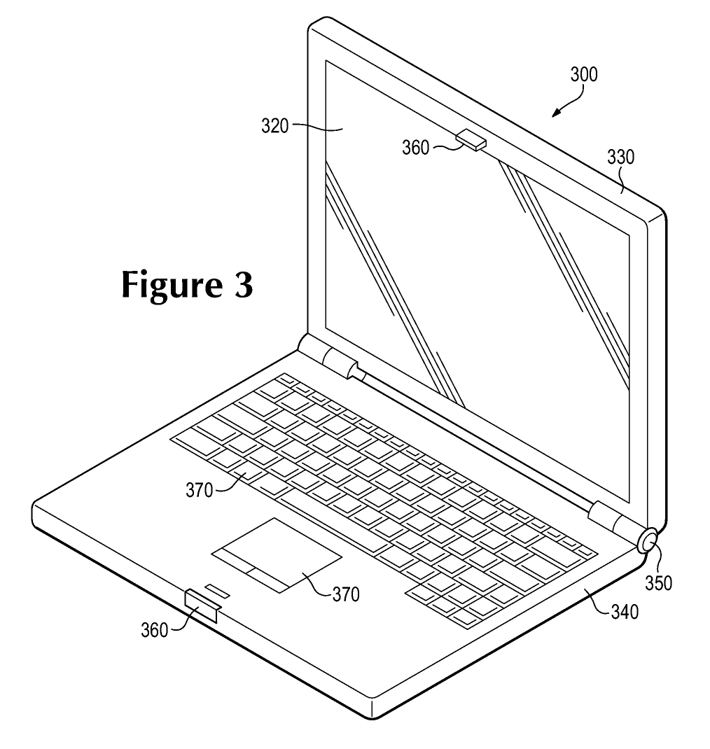

FIG. 3 illustrates a laptop 300 that is powered on when a fingerprint scanner (FIG. 1, 2, 4, 5,) detects a user according to an embodiment of the invention. As noted above, in one embodiment, the machine is a laptop 300. As illustrated in FIG. 3, the laptop 300 includes a display device 320 enclosed in a lid 330, a base 340, a hinge 350, and a locking mechanism 360. Additionally, as illustrated in FIG. 3, input devices 370 such as a keyboard and a mouse track pad are positioned in the base 340.

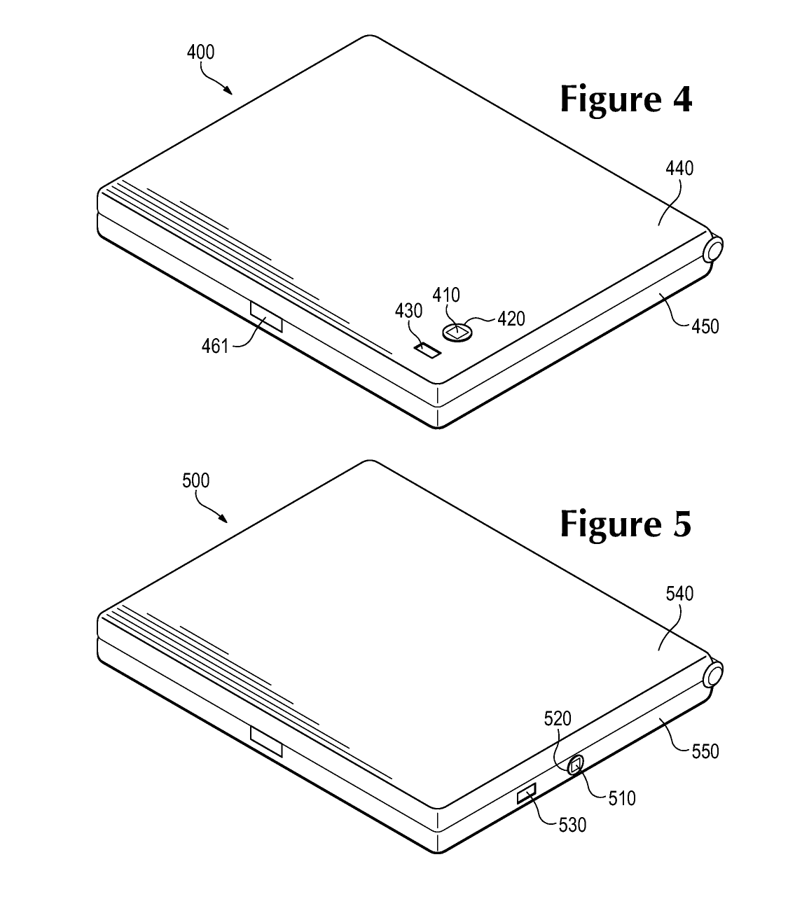

The display device 320 is a device that outputs still and/or moving images. In one embodiment, the display device 320 is a LCD screen, touch screen, and/or a monitor that displays text, images, and/or patterns. As illustrated in FIG. 3, the display device 320 is coupled to and enclosed in the lid 330 of the laptop 300. The lid 330 is an enclosure that houses the display device 320 and other components of the laptop 300. In one embodiment, a composition of the lid 330 includes, but is not limited to, alloys, plastics, and/or a combination of the above. Additionally, as noted above, a fingerprint scanner, coupled on a power button, is disposed on an exterior of the lid 300 (FIGS. 4 and 5) and is accessible when the laptop 300 is in a closed position. The laptop 300 is in a closed position when a locking mechanism 360 on the laptop 300 couples the lid 330 of the laptop 300 with the base 340 of the laptop 300. As illustrated in FIG. 3, a portion of the locking mechanism 360 is coupled to the lid 330.

As noted above, the lid 330 is coupled to a base 340 of the laptop through a hinge 350. The hinge 350 of the laptop 300 is a component which couples the lid 330 to the base 340 and allows the lid 330 and/or the base 340 to open, dose, or reposition. The base 340 is an enclosure that houses input devices 370, such as a keyboard, a mouse track pad, and/or other additional components of the laptop 300. As illustrated in FIG. 3, a portion of the locking mechanism 360 is coupled to the base 340.

As noted above, in one embodiment, the locking mechanism 360 is a device that securely couples the lid 330 of the laptop 300 to the base 340 of the laptop 300 so as to restrict a user from accessing the laptop 300. As a result, access to the display device 320 is also restricted. In one embodiment, the locking mechanism 360 is a mechanical device. When the laptop 300 is closed and the lid 330 comes in contact with the base 340, the two portions of the locking mechanism 360 couples together and locks. The two portions of the locking mechanism 360 are configured to latch together and/or rotors from the two portions are configured to move or rotate into a locked position.

Upon instruction from an authentication application and/or while the laptop 300 is powering on, the locking mechanism 360 is configured to unlock by releasing the latches and/or having the rotors move or rotate into an unlocked position. As a result, the portions of the locking mechanism 360 at the lid 330 and the base 340 are no longer latched and/or locked, and the laptop 300 is accessible. As noted above, in one embodiment, the locking mechanism 360 is configured to unlock when the authentication application authenticates the user or while the laptop 300 is powering on. As a result, by releasing the locking mechanism 360 in response to authentication of the user fingerprint image or while the machine is powering on, access to the display device 320 is also granted.

In another embodiment, the locking mechanism 360 is an electromagnetic device and includes at least one magnet. In one embodiment, the lid 330 of the laptop 300 includes one magnet acting as part of the locking mechanism 360 and the base 340 of the laptop 300 includes an additional magnet acting as another part of the locking mechanism 360. The electromagnetic locking mechanism 360 is a magnetic device that is configured to modify a polarity of at least one magnet upon instruction by the authentication application to remain in a locked or unlocked state.

When the magnets on the lid 330 and base 340 come in contact, the magnets couple and attach to one another, Upon instruction from the authentication application when a user has been authenticated or while the machine is powering on, an electrical device coupled to at least one of the magnets is instructed by the authentication application to reverse a magnetic polarity. As a result, the magnets on the lid 330 and the base 340 will repel and the laptop 300 is accessible. Other suitable locking mechanisms may alternatively be employed.

FIG. 4 illustrates a fingerprint scanner 410 on a power 420 button and a status indicator 430 positioned on a lid 440 of a laptop 400 according to an embodiment of the invention. As shown in FIG. 4, in one embodiment, the fingerprint scanner 410 and the power button 420 are disposed on the top of a lid 440 of the laptop 400 and are accessible to a user when the laptop 400 is dosed. As noted above and illustrated if FIG. 4, the laptop 400 is dosed when the lid 440 of the laptop 400 is coupled to the base 450 of the laptop 400 with a locking mechanism 461.

Further, as shown in FIG. 4, a status indicator 430 is further deposed on a lid of the laptop and is visible and/or audible to a user when the laptop 400 is dosed. As a result, the user is able to view and/or hear the signals from the status indicator 430 if an authentication of the user has failed. In one embodiment, the status indicator 430 also emits an audio and/or video signal when a user has successfully been authenticated by the laptop 400.

FIG. 5 illustrates a fingerprint scanner 510 on a power button 520 and a status indicator 530 positioned on a base 550 of a laptop 500 according to an embodiment of the invention. As illustrated in FIG. 5, in one embodiment, the fingerprint scanner 510, coupled on the power button 520, is disposed on the side of the base 550 of the laptop 500. As a result, the fingerprint scanner 510 is accessible to a user from the side of the base 540 of the laptop 500 when the laptop 500 is closed. Additionally, as illustrated in FIG. 5, the status indicator 530 is also disposed on the side of the base 550 of the laptop 500 and is positioned such that a user is able to view and/or hear the visual and/or audio signals produced from the status indicator 530 while the laptop 500 is closed.

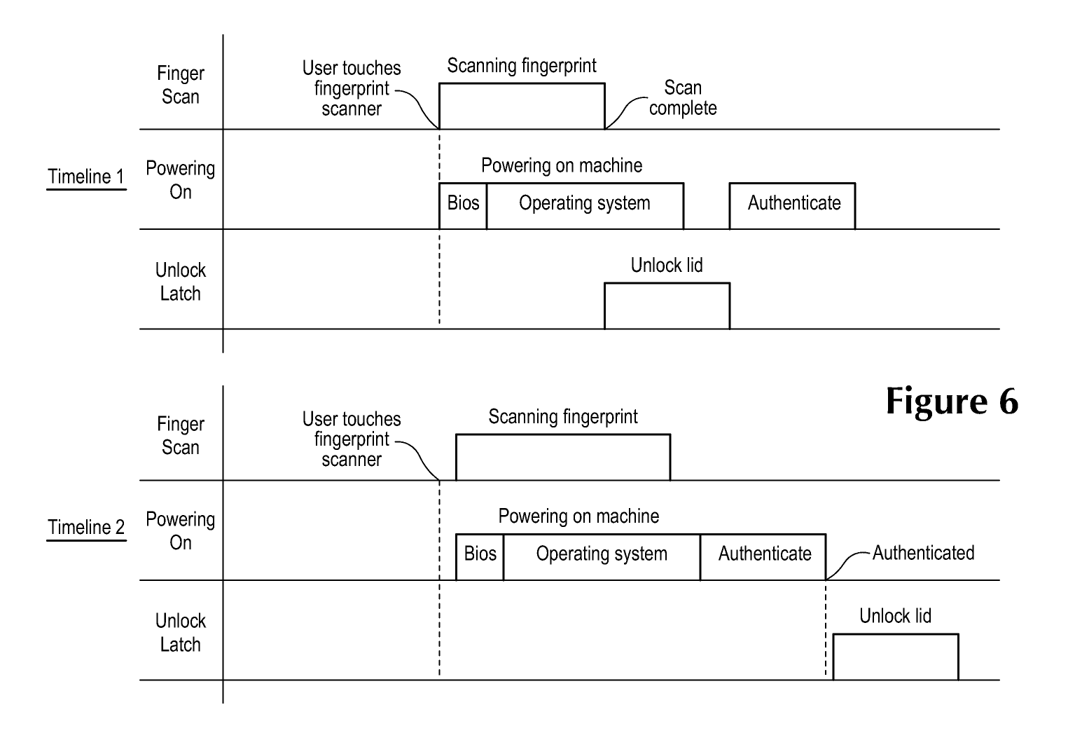

FIG. 6 illustrates timelines of a fingerprint scanner scanning a fingerprint, a machine powering on, and a lid of the machine unlocking according to an embodiment of the invention. As noted above, in one embodiment, the fingerprint scanner detects a user when the user is touching the fingerprint scanner.

As shown in Timeline 1 of FIG. 6, in one embodiment, when a user initially touches a fingerprint scanner on a machine, the machine concurrently begins powering on while the fingerprint scanner begins to scan a user fingerprint of the user. As noted above, the fingerprint scanner is coupled on the power button. As a result, when a user is touching the fingerprint scanner, the user also is touching the power button. Additionally, as noted above, powering on the machine includes, loading a BIOS and an operating system on the machine. Once the operating system has finished loading, powering on the machine is complete and the machine is powered on.

As illustrated in Timeline 1, the fingerprint scanner begins to scan the user fingerprint at the same time the machine begins powering on. Further, as illustrated in FIG. 6, in one embodiment, an amount of time spent in scanning the user fingerprint is shorter than an amount of time spent in powering on the machine. Additionally, as illustrated in Timeline 1 of FIG. 6, a locking mechanism on the machine is unlocked and/or released when the fingerprint scanner has finished scanning the user fingerprint. As a result, in the present embodiment, the fingerprint scanner finishes scanning the user fingerprint before the machine finishes powering on and before a lid on the machine is unlocked. Further, as illustrated in Timeline 1 of FIG. 6, in one embodiment, an authentication application attempts to authenticate the user after the locking mechanism is unlocked and/or released.

Additionally, as illustrated in Timeline 2 of FIG. 6, the fingerprint scanner begins to scan a user fingerprint image while concurrently beginning powering on the machine. As illustrated in Timeline 2 of FIG. 6, in powering on the machine, the machine initially loads a BIOS of the machine. Once the BIOS has been loaded, the BIOS loads an operating system of the machine, After the operating system of the machine has finished loading, the machine is powered on and an authentication application compares a user fingerprint image scanned by the fingerprint scanner with stored fingerprints in order to attempt to authenticate the user. Further, as shown in Timeline 2 of FIG. 6, in one embodiment, a locking mechanism on the machine does not unlock and/or release until the user fingerprint has been authenticated by the authentication application. Other suitable timelines may be used in other embodiments.

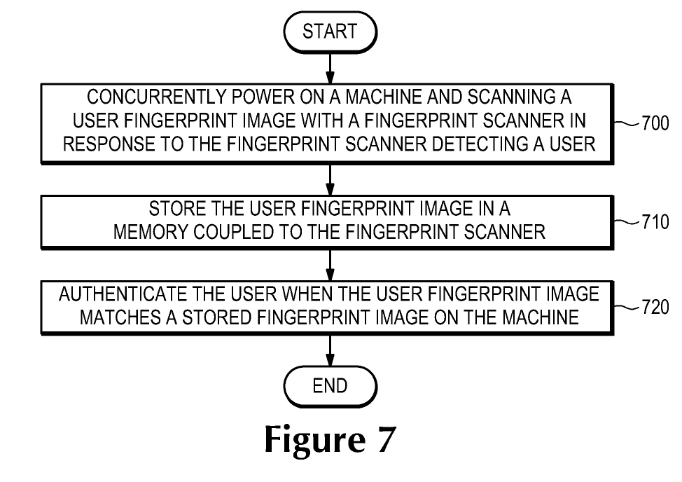

FIG. 7 is a flow chart illustrating a method for authenticating a user according to an embodiment of the invention. The method of FIG. 7 uses a machine with a fingerprint scanner coupled to the machine and an authentication application. Additionally, as noted above, the fingerprint scanner is on a power button and includes image memory. In other embodiments, the method of FIG. 7 uses additional components and/or devices in addition to and/or in lieu of those noted above and illustrated in FIGS. 1, 2, 3, 4, and 5.

In one embodiment, when a fingerprint scanner detects a user, the machine is concurrently going through the process of powering on while the fingerprint scanner scans a user fingerprint 700. As noted above, the fingerprint scanner detects a user with a sensor included in the fingerprint scanner. Additionally, in one embodiment, as noted above, the user is detected when the user is touching, pressing, and/or within proximity of the fingerprint scanner. When the fingerprint scanner detects the user, the fingerprint scanner sends a signal to the power button to begin powering on the machine. Additionally, once the user's fingerprint has been scanned, a user finger image of the user's fingerprint is stored 710. In one embodiment, the user fingerprint image is stored in image emory included in the fingerprint scanner. In other embodiments, the user finger fingerprint image is stored in a storage device accessible to the machine.

As noted above, the machine is considered to be powered on when a BIOS and an operating system on the machine have been loaded. Once the operating system has been loaded, an authentication application authenticates the user when the authentication application determines that the user fingerprint image matches one of the stored fingerprint images (stored fingerprints) on the machine 720. In one embodiment, the method is then complete. In other embodiments, the method of FIG. 7 includes additional steps in addition to and/or in lieu of those depicted in FIG. 7.

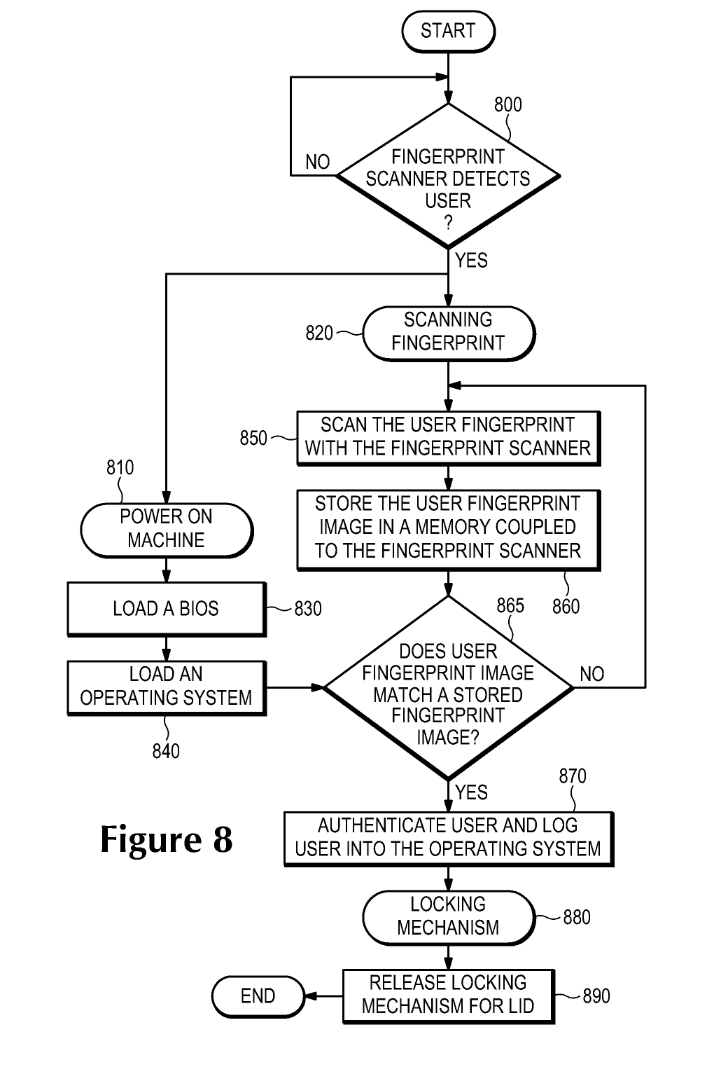

FIG. 8 is a flow chart illustrating a method for authenticating a user according to another embodiment of the invention. The method of FIG. 8 uses a machine which includes a fingerprint scanner on a power button. Additionally, the method uses a BIOS, an operating system, at least one storage device, and a locking mechanism. In other embodiments, the method of FIG. 8 uses additional components and/or devices in addition to and/or in lieu of those noted above and illustrated in FIGS. 1, 2, 3, 4, and 5.

As illustrated in FIG. 8, the fingerprint scanner initially determines whether a user is detected 800. As noted above, the fingerprint scanner detects a user when the user is touching, pressing, and/or within proximity of the fingerprint scanner. If the fingerprint scanner has not detected a user, the fingerprint scanner continues to scan for a user 800. Once a user is detected, the machine concurrently begins powering on 810 and scans a user fingerprint with the fingerprint scanner 820. As noted above, in powering on the machine, a BIOS of the machine is initially loaded 830. Once the BIOS has been loaded, the BIOS executes an instruction to load an operating system for the machine 840.

While the machine is powering on, the fingerprint scanner concurrently scans the user fingerprint with the fingerprint scanner 850 and stores the user fingerprint image in a memory coupled to the fingerprint scanner 860. As noted above, in one embodiment, the user fingerprint image and the stored fingerprints are stored on image memory. In other embodiments, the user fingerprint image and the fingerprint images are stored on a storage device accessible to the machine. Once the user fingerprint has been stored and the operating system on the machine has been loaded, an authentication application determines whether the user fingerprint matches a stored fingerprint image or data (stored fingerprints) on the machine 865. As noted above, in one embodiment, the authentication application scans the stored fingerprints to determine whether the user fingerprint image matches any of the stored fingerprints.

If the user fingerprint image matches a stored fingerprint image or data (stored fingerprints), then the operating system will authenticate the user and log the user into the operating system 870. Additionally, the authentication application will access a locking mechanism 880. If no match is found, the machine prompts the user through a status indicator coupled to the machine to prepare to have a fingerprint rescanned with the fingerprint scanner 850. In one embodiment, the machine additionally allows a user to authenticate themselves through an input device, such as a keyboard, coupled to the machine when the user fingerprint image does not match the stored fingerprints.

As noted above, if the user has been authenticated, the authentication application will access the locking mechanism 880. In one embodiment, the machine configures a locking mechanism on the machine to release and grant the user access to the machine 890, In other embodiments, the locking mechanism is configured to release once the fingerprint scanner has finished scanning and storing the user's fingerprint image and before the user has been authenticated. As noted above, the locking mechanism is a mechanical device and/or is an electromagnetic lock. In other embodiments, the method of FIG. 8 includes additional steps in addition to and/or in lieu of those depicted in FIG. 8.

By utilizing a fingerprint scanner coupled on a power button, when the fingerprint scanner detects a user, the single act of the fingerprint scanner detecting the user results in the fingerprint scanner beginning to scan and store a user's fingerprint image while a machine concurrently begins powering on. As a result, time is saved and user friendliness is increased by automatically authenticating the user's fingerprint image with stored fingerprints once the machine has powered on. Additionally, by configuring a locking mechanism on the machine to unlock after the user fingerprint image has been authenticated, security for the machine and a user's account is further increased.

What is claimed is:

1. A machine comprising;
a processor;
a power button;
a fingerprint scanner on the power button; and
an authentication application executable by the processor o compare a user fingerprint image with stored fingerprint data.

2. The machine of claim 1 further comprising a locking mechanism configured to lock a lid of the machine to a base of the machine.

3. The machine of claim 2 wherein the locking mechanism is configured to unlock when the user fingerprint image scanned by the fingerprint scanner matches a stored fingerprint image on the machine.

4. The machine of claim 1 further comprising a status indicator configured to output a visual or auditory signal when the user fingerprint image scanned by the fingerprint scanner does not match a stored fingerprint image on the machine.

5. The machine of claim 1 wherein the fingerprint scanner begins to scan the user fingerprint image while the machine concurrently begins powering on.

6. The machine of claim 1 wherein the fingerprint scanner includes image memory to store the user fingerprint image scanned by the fingerprint scanner.

7. A machine comprising:
a processor coupled to computer readable memory;
a fingerprint scanner;
wherein the machine begins powering on in response to the fingerprint scanner detecting a user.

8. The machine of claim 7 wherein the fingerprint scanner concurrently scans a user fingerprint image while the machine is powering on.

9. The machine of claim 7 further comprising:
a lid coupled to a display device;
a base; and
a locking mechanism configured to lock the lid to the base.

10. The machine of claim 7 further comprising:
a base;
a hinge; and
a lid coupled to a display device;
wherein the fingerprint scanner is disposed on an exterior of he lid and is accessible when the lid is coupled to the base.

11. A method for authenticating a user comprising:
concurrently powering on a machine and scanning a user fingerprint image with a fingerprint scanner in response to the fingerprint scanner detecting the user;
storing the user fingerprint image in a memory coupled to the fingerprint scanner; and
authenticating the user when the user fingerprint image matches a stored fingerprint image on the machine.

12. The method for authenticating a user of claim 11 further comprising instructing the machine to concurrently release a locking mechanism for a display device coupled to the machine while the machine is powering on.

13. The method for authenticating a user of claim 11 wherein the machine further includes a display device locked to a base of the machine and a locking mechanism configured to release the display device in response to authentication of the user fingerprint.

14. The method for authenticating a user of claim 11 wherein the fingerprint scanner is on a power button of the machine.

15. The method for authenticating a user of claim 11 wherein the machine is powered on in response to the fingerprint scanner detecting the user.
